(19) United States
(12) Patent Application Publication
(10) Pub. No.: US 2022/0091459 A1
(43) Pub. Date: Mar. 24, 2022

(54) DISPLAY DEVICE

(71) Applicant: Japan Display Inc., Tokyo (JP)

(72) Inventor: Kentaro OKUYAMA, Tokyo (JP)

(21) Appl. No.: 17/542,678

(22) Filed: Dec. 6, 2021

Related U.S. Application Data
(63) Continuation of application No. PCT/JP2020/004051, filed on Feb. 4, 2020.

(30) Foreign Application Priority Data
Jun. 7, 2019 (JP) 2019-107088

(51) Int. Cl. G02F 1/1333; G02F 1/1339; G02F 1/1334

(52) U.S. Cl. CPC G02F 1/133331; G02F 1/1334; G02F 1/13394

(57) ABSTRACT

According to one embodiment, a display device includes a display panel including a display area and a non-display, a frame that surrounds a peripheral portion of the display panel and exposes a part of the non-display area and the display area, and a light emitting element overlapping the frame. The display panel includes a first transparent substrate, a second transparent substrate including a side surface facing the light emitting element, and a liquid crystal layer provided between the first transparent substrate and the second transparent substrate and containing a polymer and a liquid crystal molecule. The part of the non-display area is located between the frame and the display area in planar view.

### CROSS-REFERENCE TO RELATED APPLICATIONS

This application is a Continuation Application of PCT Application No. PCT/JP2020/004051, filed Feb. 4, 2020 and based upon and claiming the benefit of priority from Japanese Patent Application No. 2019-107088, filed Jun. 7, 2019, the entire contents of all of which are incorporated herein by reference.

### FIELD

Embodiments described herein relate generally to a display device.

### BACKGROUND

In recent years, various illumination devices including a light modulating element exhibiting scattering property or transparency to light have been proposed. For example, the light modulating element includes a polymer dispersed liquid crystal layer as a light modulating layer. The light modulating element is disposed behind a light guide and scatters light incident from a side surface of the light guide.

### BRIEF DESCRIPTION OF THE DRAWINGS

FIG. 1 is a plane view illustrating a first configuration example of a display device DSP of an embodiment.

FIG. 2 is a cross-sectional view of the display device DSP taken along line A-B in FIG. 1.

FIG. 3 is a plane view illustrating a configuration example of a display panel PNL illustrated in FIG. 1.

FIG. 4 is a cross-sectional view illustrating a configuration example of the display panel PNL illustrated in FIG. 1.

FIG. 5 is a cross-sectional view illustrating a second configuration example of the display device DSP.

FIG. 6 is a cross-sectional view illustrating a third configuration example of the display device DSP.

FIG. 7 is a plane view illustrating a fourth configuration example of the display device DSP.

FIG. 8 is a cross-sectional view illustrating an example of the display device DSP illustrated in FIG. 7.

FIG. 9 is a cross-sectional view illustrating another example of the display device DSP illustrated in FIG. 7.

FIG. 10 is a plane view illustrating a fifth configuration example of the display device DSP.

FIG. 11 is a cross-sectional view illustrating an example of the display device DSP illustrated in FIG. 10.

FIG. 12 is a cross-sectional view illustrating another example of the display device DSP illustrated in FIG. 10.

### DETAILED DESCRIPTION

In general, according to one embodiment, a display device comprises a display panel including a display area and a non-display area that surrounds the display area and has optical transparency, a frame that surrounds a peripheral portion of the display panel and exposes a part of the non-display area and the display area, and a light emitting element overlapping the frame, wherein the display panel comprises a first transparent substrate, a second transparent substrate comprising a side surface facing the light emitting element, and a liquid crystal layer provided between the first transparent substrate and the second transparent substrate and containing a polymer and a liquid crystal molecule, and the part of the non-display area is located between the frame and the display area in planar view.

According to another embodiment, a display device comprises a display panel including a first transparent substrate, a second transparent substrate, and a liquid crystal layer provided between the first transparent substrate and the second transparent substrate and containing a polymer and a liquid crystal molecule, a first cover member located on a side of the first transparent substrate opposite to the liquid crystal layer, a second cover member located on a side of the second transparent substrate opposite to the liquid crystal layer, a first spacer provided between the first cover member and the first transparent substrate, and a second spacer provided between the second cover member and the second transparent substrate, wherein in cross-sectional view, air layers are each located between the first cover member and the first transparent substrate and between the second cover member and the second transparent substrate.

According to another embodiment, a display device comprises a display panel including a first transparent substrate, a second transparent substrate, and a liquid crystal layer provided between the first transparent substrate and the second transparent substrate and containing a polymer and a liquid crystal molecule, a first cover member located on a side of the first transparent substrate opposite to the liquid crystal layer, a second cover member located on a side of the second transparent substrate opposite to the liquid crystal layer, a first transparent layer provided between the first cover member and the first transparent substrate in cross-sectional view, and a second transparent layer provided between the second cover member and the second transparent substrate in cross-sectional view, wherein the first transparent layer is in contact with the first transparent substrate and has a lower refractive index than the first transparent substrate, and the second transparent layer is in contact with the second transparent substrate and has a lower refractive index than the second transparent substrate.

According to the present embodiment, it is possible to provide a display device capable of suppressing degradation in display quality.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

### First Configuration Example

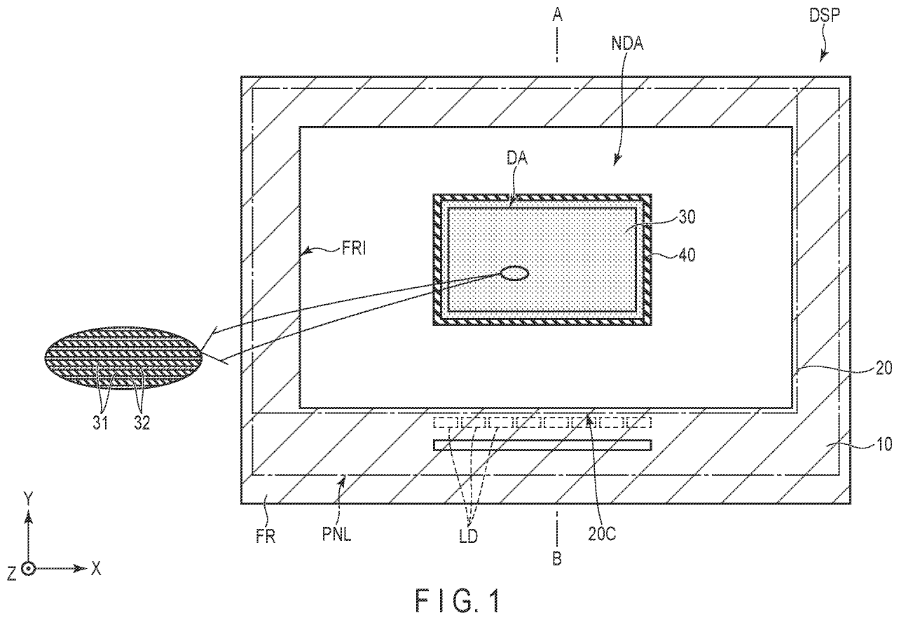

FIG. 1 is a plan view showing a configuration of a display device DSP according to one embodiment. For example, a first direction X, a second direction Y and a third direction Z are orthogonal to each other, but they may intersect at an angle other than 90 degrees. The first direction X and the second direction Y correspond to the directions parallel to a main surface of a substrate that constitutes the display device DSP. The third direction Z corresponds to a thickness direction of the display device DSP. In this embodiment, viewing an X-Y plane defined by the first direction X and the second direction Y is referred to as planar view. Further, viewing X-Z plane defined by the first direction X and the third direction Z or a Y-Z plane defined by the second direction Y and the third direction Z is referred to as a cross-sectional view.

The display device DSP of the present embodiment is applicable to, for example, a window of a building, a windshield of a vehicle, and the like.

The display device DSP includes a display panel PNL, a frame FR, and a light emitting element LD. The display panel PNL includes a display area DA and a non-display area NDA having optical transparency (substantially transparent). In the example illustrated in FIG. 1, the display area DA is located substantially at a central portion of the display panel PNL and is located in an inside surrounded by the non-display area NDA.

The display panel PNL includes a first transparent substrate 10, a second transparent substrate 20, a liquid crystal layer 30, and a sealant 40. In FIG. 1, the outer shapes of the first transparent substrate 10 and the second transparent substrate 20 are indicated by dash-dotted lines. The first transparent substrate 10 and the second transparent substrate 20 overlap each other in planar view. The sealant 40 bonds the first transparent substrate 10 and the second transparent substrate 20 to each other. In addition, the sealant 40 is provided between the display area DA and the non-display area NDA, and seals the liquid crystal layer 30 in the display area DA.

As schematically illustrated in an enlarged manner in FIG. 1, the liquid crystal layer 30 includes a polymer dispersed liquid crystal containing polymers 31 and liquid crystal molecules 32. For example, the polymers 31 are liquid crystal polymers. The polymers 31 are formed in a streak shape extending along a first direction X and are arranged in a second direction Y. The liquid crystal molecules 32 are dispersed in gaps between the polymers 31, and are aligned such that their long axes are along the first direction X. Each of the polymers 31 and the liquid crystal molecules 32 has optical anisotropy or refractive anisotropy. The responsiveness of the polymers 31 to the electric field is lower than the responsiveness of the liquid crystal molecules 32 to the electric field.

For example, the alignment direction of the polymers 31 hardly changes regardless of the presence or absence of the electric field. In contrast, the alignment direction of the liquid crystal molecules 32 changes according to the electric field in a state where a high voltage equal to or higher than a threshold value is applied to the liquid crystal layer 30. In a state where no voltage is applied to the liquid crystal layer 30, the optical axes of the polymers 31 and liquid crystal molecules 32 are parallel to each other, and the light incident on the liquid crystal layer 30 is transmitted without being almost scattered in the liquid crystal layer 30 (transparent state). In a state where a voltage is applied to the liquid crystal layer 30, the optical axes of the polymers 31 and liquid crystal molecules 32 cross each other, and the light incident on the liquid crystal layer 30 is scattered in the liquid crystal layer 30 (scattered state).

The frame FR surrounds a peripheral portion of the display panel PNL and exposes a part of the non-display area NDA and the display area DA. The light emitting element LD overlaps the frame FR in planar view. The plurality of light emitting elements LD are arranged spaced apart along the first direction X.

Focusing on a positional relationship between the display panel PNL and the frame FR, a part of the transparent non-display area NDA is located between the frame FR and the display area DA in planar view. In the example illustrated in FIG. 1, the sealant 40 is located inside the frame FR in planar view, and the entire area between an inner end FRI of the frame FR and the display area DA is a transparent non-display area NDA. In addition, an area between the light emitting element LD and the display area DA is also a transparent non-display area NDA.

Incidentally, the liquid crystal layer 30 may be provided in the non-display area NDA. At least a part of the sealant 40 may overlap the frame FR.

The light emitting element LD is, for example, a light-emitting diode, and includes a red light emitting portion, a green light emitting portion, and a blue light emitting portion although not described in detail. These light emitting elements LD face a side surface 20C of the second transparent substrate 20 in the second direction Y, and emit light toward the side surface 20C. The side surface 20C extends along the first direction X in planar view. Incidentally, a transparent light guide may be disposed between the light emitting element LD and the side surface 20C.

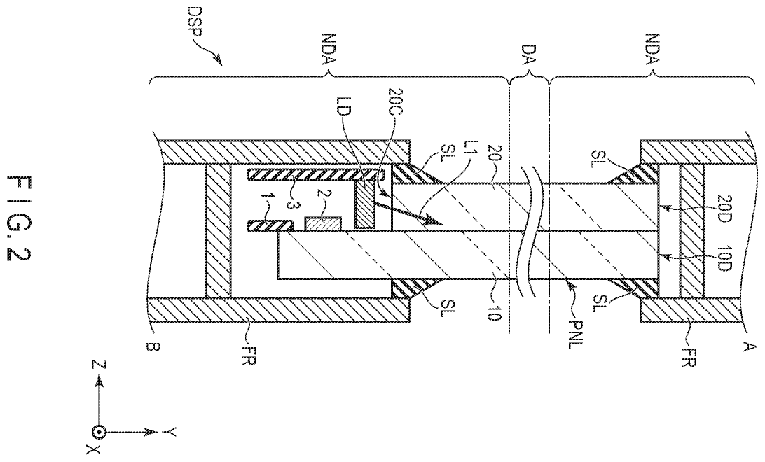

FIG. 2 is a cross-sectional view of the display device DSP taken along line A-B in FIG. 1. Incidentally, the liquid crystal layer and the sealant are not illustrated in FIG. 2. For example, when the display device DSP is applied as a window, the first transparent substrate 10 and the second transparent substrate 20 constitute a window glass, and the frame FR constitutes a window frame. Incidentally, the display device DSP is not limited to the example illustrated in FIG. 2, and may include a cover member that covers the first transparent substrate 10 and a cover member that covers the second transparent substrate 20. In this case, the cover member may constitute the window glass. A sealing agent (or a caulking agent) SL is provided in a gap between the frame FR and the display panel PNL.

A wiring substrate 1 and an IC chip 2 overlap the frame FR in a third direction Z. The wiring substrate 1 and the IC chip 2 are electrically connected to electrodes provided on the first transparent substrate 10. The wiring substrate 1 is, for example, a bendable flexible printed circuit board. The IC chip 2 incorporates, for example, a display driver that outputs a signal necessary for image display. Incidentally, the IC chip 2 may be mounted on the wiring substrate 1. The light emitting element LD is mounted on the wiring substrate 3.

The second transparent substrate 20 has a side surface 20D opposite to the side surface 20C. The first transparent substrate 10 has a side surface 10D. The side surface 10D and the side surface 20D overlap the frame FR in the third direction Z.

Next, light L1 emitted from the light emitting element LD will be described with reference to FIG. 2.

The light emitting element LD emits the light L1 toward the side surface 20C. The light L1 emitted from the light emitting element LD travels along an arrow direction indicating the second direction Y, and is incident on the second transparent substrate 20 from the side surface 20C. The light L1 incident on the second transparent substrate 20 travels inside the display panel PNL while being repeatedly reflected. In the display area DA illustrated in FIG. 1, the light L1 incident on the liquid crystal layer 30 to which no voltage is applied is transmitted through the liquid crystal layer 30 with little scattering. In addition, the light L1 incident on the liquid crystal layer 30 to which a voltage is applied is scattered by the liquid crystal layer 30. The light L1 that has passed through the display area DA reaches the side surfaces 10D and 20D. The display device DSP can be observed from the first transparent substrate 10 side and can also be observed from the second transparent substrate 20 side. In addition, even when the display device DSP is observed from the first transparent substrate 10 side or the second transparent substrate 20 side, the background of the display device DSP can be observed through the display device DSP.

According to the present embodiment, the display area DA having a desired size can be formed regardless of the size of the window glass, and moreover, the display area DA can be formed at any position.

In addition, even if the light L1 reaching the side surfaces 10D and 20D is scattered on the side surfaces 10D and 20D, since the side surfaces 10D and 20D overlap the frame FR, the scattered light is less likely to be visually recognized, and degradation in display quality can be suppressed.

In addition, in a comparative example in which the window glass is hollowed out and the display panel is fitted, light from the light emitting element may be scattered near the boundary between the window glass and the display panel. In contrast, according to the present embodiment, since a part of the window glass functions as the display panel, there is no boundary between the window glass and the display panel, and undesirable scattering can be suppressed.

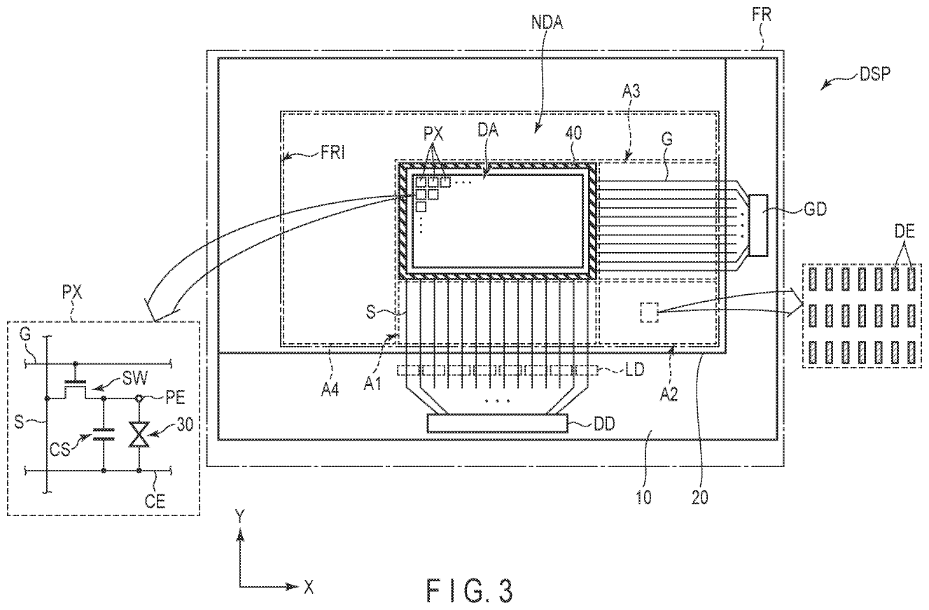

FIG. 3 is a plane view illustrating a configuration example of a display panel PNL illustrated in FIG. 1. In FIG. 3, the frame FR is indicated by dash-dotted lines.

The display area DA includes pixels PX arrayed in a matrix in the first direction X and the second direction Y. As illustrated in an enlarged manner in FIG. 3, each pixel PX includes a switching element SW, a pixel electrode PE, a common electrode CE, a liquid crystal layer 30, and the like. The switching element SW is constructed from, for example, a thin-film transistor (TFT) and is electrically connected to a scanning line G and a signal line S. The scanning line G is electrically connected to the switching element SW in each of the pixels PX arranged in the first direction X. The signal line S is electrically connected to the switching element SW in each of the pixels PX arranged in the second direction Y. The pixel electrode PE is electrically connected to the switching element SW. The common electrode CE is provided in common for the plurality of the pixel electrodes PE. The liquid crystal layer 30 (in particular, liquid crystal molecules 32) is driven by an electric field generated between the pixel electrode PE and the common electrode CE. A capacitance CS is formed, for example, between an electrode having the same electric potential as the common electrode CE and an electrode having the same electric potential as the pixel electrode PE. As will be described later, the scanning line G, the signal line S, the switching element SW, and the pixel electrode PE are provided on the first transparent substrate 10, and the common electrode CE is provided on the second transparent substrate 20.

The signal line S is drawn out to the non-display area NDA and is electrically connected to a display driver DD. The scanning line G is drawn out to the non-display area NDA and is electrically connected to a gate driver GD. The display driver DD is incorporated in the IC chip 2 illustrated in FIG. 2, but a part thereof may be formed on the first transparent substrate 10. The gate driver GD may be formed on the first transparent substrate 10, may be incorporated in the IC chip 2, or may be incorporated in another IC chip.

The non-display area NDA includes a first region A1, a second region A2, a third region A3, and a fourth region A4.

The first region A1 is a region between the inner end FRI of the frame FR and the sealant 40 in the second direction Y. The plurality of signal lines S drawn out from the display area DA toward the display driver DD constitute a wiring line group provided in the first region A1. In the first region A1, the plurality of signal lines S are fine metal lines, and are arranged at intervals in the first direction X. For this reason, the first region A1 is a wiring line region in which the wiring line group is provided, but has optical transparency.

The third region A3 is a region between the sealant 40 and the inner end FRI of the frame FR in the first direction X. The plurality of scanning lines G drawn out from the display area DA toward the gate driver GD constitute a wiring line group provided in the third region A3. In the third region A3, the plurality of scanning lines G are fine metal lines, and are arranged at intervals in the second direction Y. For this reason, the third region A3 is a wiring line region in which the wiring line group is provided, but has optical transparency.

The fourth region A4 corresponds to a non-wiring line region of the non-display area NDA where a light-shielding member such as a metal line is not provided. Each of the first region A1 and the third region A3 has a lower transmittance than the fourth region A4.

The first region A1 and the second region A2 are arranged in the first direction X. The second region A2 and the third region A3 are arranged in the second direction Y. The second region A2 corresponds to a non-wiring line region where no wiring line or electrode necessary for driving the pixel PX is provided, but as illustrated in an enlarged manner in FIG. 3, a plurality of dummy electrodes DE are provided therein. The dummy electrodes DE are formed of, for example, a metal material similar to the scanning lines G, the signal lines S, and the like. The transmittance of the second region A2 is equal to the transmittance of the first region A1. Alternatively, the transmittance of the second region A2 is equal to the transmittance of the third region A3. Alternatively, a difference in transmittance between the first region A1 and the second region A2 is smaller than a difference in transmittance between the first region A1 and the fourth region A4. Alternatively, a difference in transmittance between the second region A2 and the third region A3 is smaller than a difference in transmittance between the third region A3 and the fourth region A4. This allows the wiring line groups such as the plurality of signal lines S and the plurality of scanning lines G drawn out to the non-display area NDA to be made inconspicuous.

Incidentally, the dummy electrodes DE may be provided in the entire fourth region A4, a region adjacent to the first region A1 in the fourth region A4, or a region adjacent to the third region A3 in the fourth region A4. In addition, although the dummy electrodes DE are provided to control the transmittance of the second region A2, the present invention is not limited to this example, and a light-shielding member formed of a conductive material or an insulating material may be provided instead of the dummy electrodes DE.

In addition, when it is necessary to enhance visibility of the position where the display area DA is provided, the sealant 40 surrounding the display area DA may include a scattering body. Alternatively, a voltage may be applied to the liquid crystal layer 30 so that the pixels PX on the outermost periphery of the display area DA are in a scattered state.

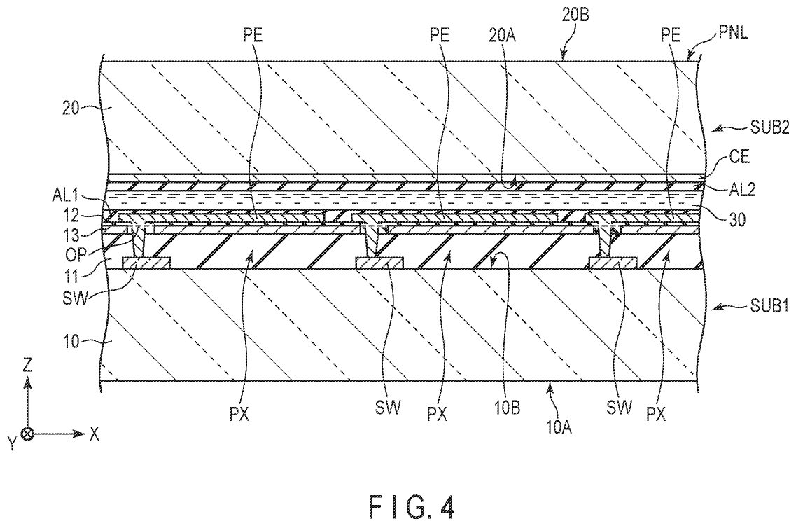

FIG. 4 is a cross-sectional view illustrating a configuration example of the display panel PNL illustrated in FIG. 1. Here, a configuration example of a first substrate SUB1 including the first transparent substrate 10 and a second substrate SUB2 including the second transparent substrate 20 will be described.

The first substrate SUB1 includes the first transparent substrate 10, insulating films 11 and 12, a capacitive electrode 13, the switching element SW, the pixel electrode PE, and an alignment film AL1. The first transparent substrate 10 includes an outer surface 10A and an inner surface 10B opposite to the outer surface 10A. The switching element SW is provided on the inner surface 10B side. The insulating film 11 is provided on the inner surface 10B and covers the switching element SW. Incidentally, the scanning lines G and the signal lines S illustrated in FIG. 3 are provided between the first transparent substrate 10 and the insulating film 11, but are not illustrated here. The capacitive electrode 13 is provided between the insulating films 11 and 12. The pixel electrode PE is provided for each pixel PX between the insulating film 12 and the alignment film AL1. The pixel electrode PE is electrically connected to the switching element SW via an opening portion OP of the capacitive electrode 13. The pixel electrode PE overlaps the capacitive electrode 13 with the insulating film 12 interposed therebetween to form the capacitance CS of the pixel PX. The alignment film AL1 covers the pixel electrode PE. The alignment film AL1 is in contact with the liquid crystal layer 30.

The second substrate SUB2 includes the second transparent substrate 20, the common electrode CE, and an alignment film AL2. The second transparent substrate 20 includes an inner surface 20A and an outer surface 20B opposite to the inner surface 20A. The inner surface 20A of the second transparent substrate 20 faces the inner surface 10B of the first transparent substrate 10. The common electrode CE is provided on the inner surface 20A. The alignment film AL2 covers the common electrode CE. The alignment film AL2 is in contact with the liquid crystal layer 30. Incidentally, in the second substrate SUB2, a light-shielding layer may be provided directly above the switching elements SW, the scanning lines G, and the signal lines S. In addition, a transparent insulating film may be provided between the second transparent substrate 20 and the common electrode CE or between the common electrode CE and the alignment film AL2. The common electrode CE is disposed over the plurality of pixels PX and is opposed to the plurality of pixel electrodes PE in the third direction Z. In addition, the common electrode CE is electrically connected to the capacitive electrode 13, and has the same electric potential as the capacitive electrode 13.

The first transparent substrate 10 and the second transparent substrate 20 are, for example, glass substrates, but may be insulating substrates such as plastic substrates. The insulating film 11 includes, for example, a transparent inorganic insulating film such as silicon oxide, silicon nitride, or silicon oxynitride, and a transparent organic insulating film such as acrylic resin. The insulating film 12 is a transparent inorganic insulating film such as silicon nitride. The capacitive electrode 13, the pixel electrode PE, and the common electrode CE are transparent electrodes formed of a transparent conductive material such as indium tin oxide (ITO) or indium zinc oxide (IZO). The alignment films AL1 and AL2 are horizontal alignment films having an alignment restriction force approximately parallel to an X-Y plane. For example, the alignment films AL1 and AL2 are subjected to alignment treatment along the first direction X. Incidentally, the alignment treatment may be rubbing treatment or optical alignment treatment.

### Second Configuration Example

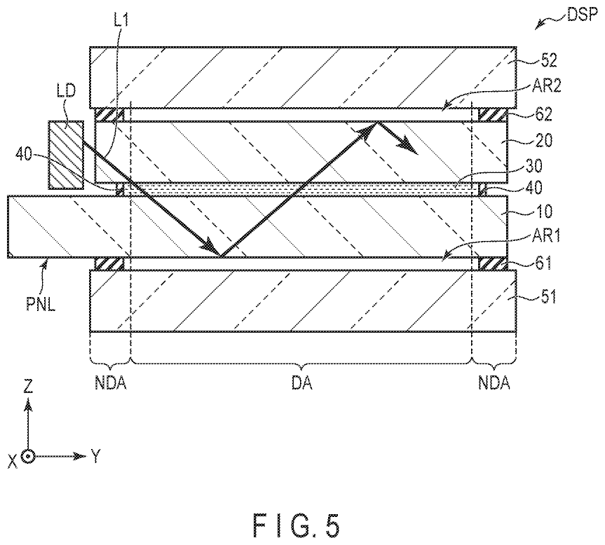

FIG. 5 is a cross-sectional view illustrating a second configuration example of the display device DSP. Incidentally, only the main part of the display panel PNL is illustrated in a simplified manner. Further, the frame is not illustrated.

The display device DSP includes a first cover member 51, a second cover member 52, a first spacer 61, and a second spacer 62. The display panel PNL is provided between the first cover member 51 and the second cover member 52 in the third direction Z. The first cover member 51 is opposed to the first transparent substrate 10 and is located on a side of the first transparent substrate 10 opposite to the liquid crystal layer 30. The second cover member 52 is opposed to the second transparent substrate 20 and is located on a side of the second transparent substrate 20 opposite to the liquid crystal layer 30.

The first spacer 61 is provided between the first cover member 51 and the first transparent substrate 10. As a result, an air layer AR1 is located between the first cover member 51 and the first transparent substrate 10. Similarly, the second spacer 62 is provided between the second cover member 52 and the second transparent substrate 20. As a result, an air layer AR2 is located between the second cover member 52 and the second transparent substrate 20.

The first spacer 61 and the second spacer 62 overlap the non-display area NDA in the third direction Z. The air layers AR1 and AR2 overlap the display area DA in the third direction Z.

According to this second configuration example, the same effects as in the first configuration example can be obtained. In addition, of the light L1 emitted from the light emitting element LD, the light L1 incident on the first transparent substrate 10 is reflected at an interface between the first transparent substrate 10 and the air layer AR1. The light L1 incident on the second transparent substrate 20 is also reflected at an interface between the second transparent substrate 20 and the air layer AR2. This allows light leaking out of the display device DSP, of the light L1, to be reduced. As a result, attenuation of the light L1 propagating through the non-display area NDA between the light emitting element LD and the display area DA is suppressed, and attenuation of the light L1 propagating through the display area DA is also suppressed. In addition, even when minute scratches are formed on the first cover member 51 and the second cover member 52, or even when stains such as fingerprints adhere to the first cover member 51 and the second cover member 52, undesirable scattering at these portions is suppressed. Therefore, it is possible to suppress degradation in display quality.

### Third Configuration Example

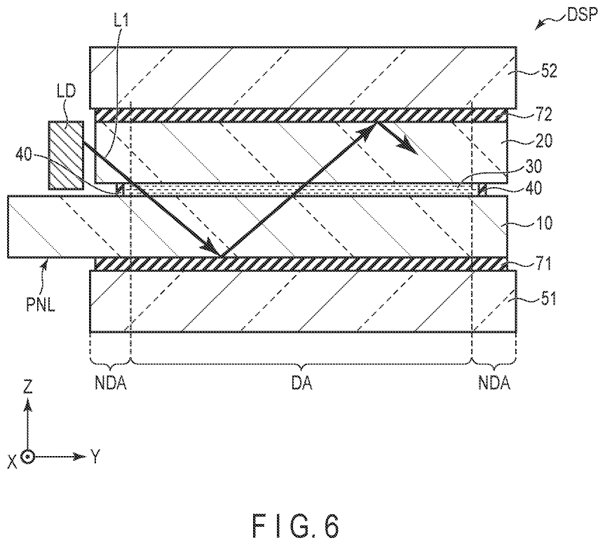

FIG. 6 is a cross-sectional view illustrating a third configuration example of the display device DSP. Incidentally, only the main part of the display panel PNL is illustrated in a simplified manner. Further, the frame is not illustrated.

The third configuration example illustrated in FIG. 6 is different from the second configuration example illustrated in FIG. 5 in that the display device DSP includes a first transparent layer 71 and a second transparent layer 72. The first transparent layer 71 is provided between the first cover member 51 and the first transparent substrate 10, and is in contact with the first transparent substrate 10. The second transparent layer 72 is provided between the second cover member 52 and the second transparent substrate 20, and is in contact with the second transparent substrate 20. The first transparent layer 71 has a lower refractive index than the first transparent substrate 10, and the second transparent layer 72 has a lower refractive index than the second transparent substrate 20. For example, the refractive index of each of the first transparent substrate 10 and the second transparent substrate 20 is about 1.5, and the refractive index of each of the first transparent layer 71 and the second transparent layer 72 is about from 1.0 to 1.4. The first transparent layer 71 and the second transparent layer 72 overlap both the display area DA and the non-display area NDA in the third direction Z.

According to this third configuration example, the same effects as in the first configuration example can be obtained. In addition, of the light L1 emitted from the light emitting element LD, the light L1 incident on the first transparent substrate 10 is reflected at an interface between the first transparent substrate 10 and the first transparent layer 71. The light L1 incident on the second transparent substrate 20 is also reflected at an interface between the second transparent substrate 20 and the second transparent layer 72. For this reason, the same effects as in the second configuration example can be obtained.

### Fourth Configuration Example

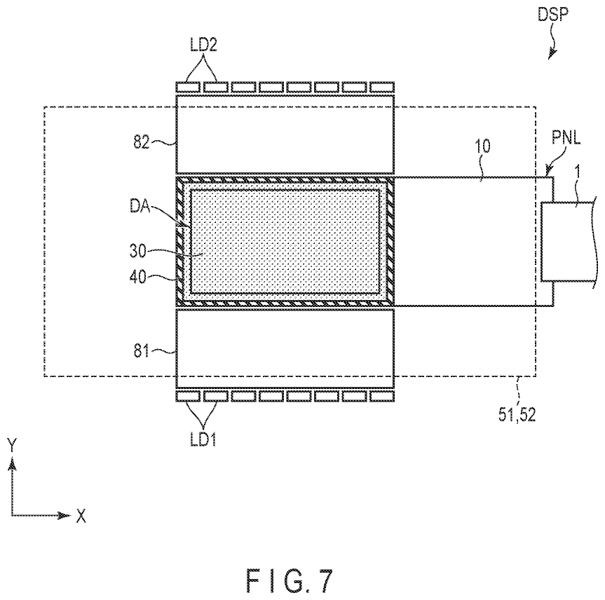

FIG. 7 is a plane view illustrating a fourth configuration example of the display device DSP. Incidentally, the first cover member 51 and the second cover member 52 are indicated by dotted lines, and the frame is not illustrated.

The display device DSP includes a first light emitting element LD1, a second light emitting element LD2, a first light guide 81, and a second light guide 82 in addition to the display panel PNL. In the display panel PNL, the first transparent substrate 10 extends in the first direction X and is electrically connected to the wiring substrate 1 and the like. Incidentally, the liquid crystal layer 30 contains the polymers 31 described with reference to FIG. 1, and the polymers 31 are formed in a streak shape extending in the first direction X.

The first light guide 81, the display panel PNL, and the second light guide 82 are arranged in this order in the second direction Y. In planar view, the first light guide 81 and the second light guide 82 do not overlap the display panel PNL. In addition, in planar view, the first light guide 81, the display panel PNL, and the second light guide 82 overlap the first cover member 51 and the second cover member 52. The first light guide 81 and the second light guide 82 are formed of, for example, transparent glass similar to the first transparent substrate 10 and the like, and have the same refractive index as the first transparent substrate 10.

The plurality of first light emitting elements LD1 and the plurality of second light emitting elements LD2 are arranged in the first direction X. These first light emitting elements LD1 and second light emitting elements LD2 are configured similarly to the light emitting elements LD.

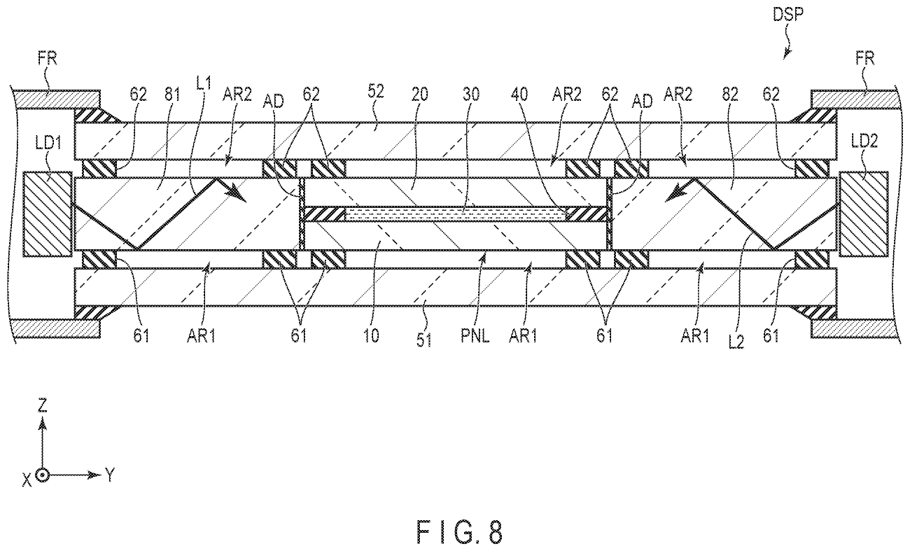

FIG. 8 is a cross-sectional view illustrating an example of the display device DSP illustrated in FIG. 7. The display device DSP illustrated in FIG. 8 corresponds to a combination of the second configuration example illustrated in FIG. 5 and the fourth configuration example illustrated in FIG. 7.

The first light guide 81 and the second light guide 82 are provided between the first cover member 51 and the second cover member 52 in the third direction Z. The first light guide 81 is provided between the first light emitting element LD1 and the display panel PNL in the second direction Y, and guides the light L1 emitted from the first light emitting element LD1 to the display panel PNL. The second light guide 82 is provided between the second light emitting element LD2 and the display panel PNL in the second direction Y, and guides light L2 emitted from the second light emitting element LD2 to the display panel PNL. The first light guide 81 and the first transparent substrate 10, and the first light guide 81 and the second transparent substrate 20 are bonded to each other with a transparent adhesive AD. Similarly, the second light guide 82 and the first transparent substrate 10, and the second light guide 82 and the second transparent substrate 20 are bonded to each other with the transparent adhesive AD. The adhesive AD described here has the same refractive index as the first transparent substrate 10 and the second transparent substrate 20. Incidentally, even without the adhesive AD, when the light emitted from each light emitting element is continuously guided through the light guide and the transparent substrate, the configuration may not be provided with the adhesive AD.

Similarly to the second configuration example, the first spacers 61 are interposed between the first cover member 51 and the first transparent substrate 10, between the first cover member 51 and the first light guide 81, and between the first cover member 51 and the second light guide 82, and the air layer AR1 is located therebetween. In addition, the second spacers 62 are interposed between the second cover member 52 and the second transparent substrate 20, between the second cover member 52 and the first light guide 81, and between the second cover member 52 and the second light guide 82, and the air layer AR2 is located therebetween.

According to this configuration example, the light L1 emitted from the first light emitting element LD1 and incident on the first light guide 81 is reflected at an interface between the first light guide 81 and the air layer AR1 and an interface between the first light guide 81 and the air layer AR2. As a result, attenuation of the light L1 is suppressed between the first light emitting element LD1 and the display panel PNL. Similarly, the light L2 emitted from the second light emitting element LD2 and incident on the second light guide 82 is reflected at an interface between the second light guide 82 and the air layer AR1 and an interface between the second light guide 82 and the air layer AR2. As a result, attenuation of the light L2 is suppressed between the second light emitting element LD2 and the display panel PNL.

In addition, in the display panel PNL, an area close to the first light emitting element LD1 is mainly illuminated by the light L1, an area close to the second light emitting element LD2 is mainly illuminated by the light L2, and an area near the middle between the first light emitting element LD1 and the second light emitting element LD2 is illuminated by the light L1 and L2. For this reason, the luminance is uniformized in the display panel PNL. Therefore, it is possible to suppress degradation in display quality due to luminance degradation.

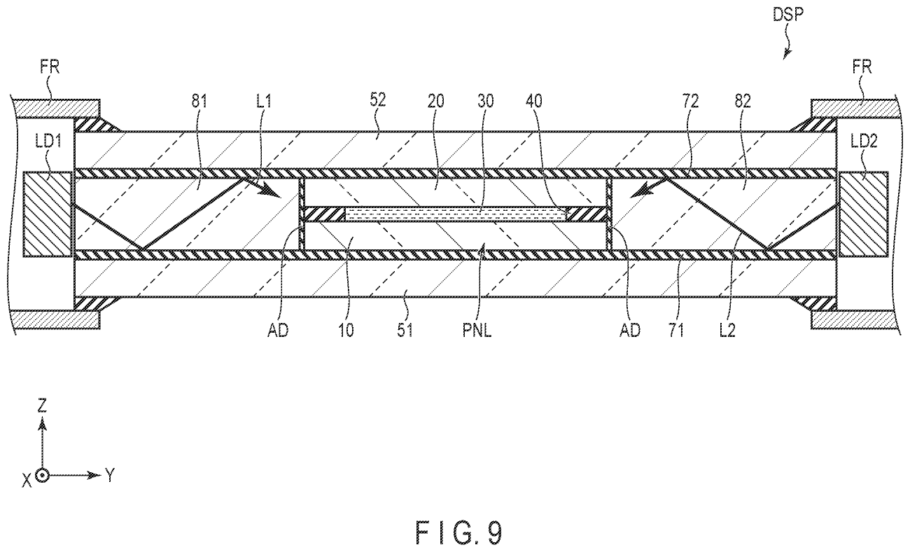

FIG. 9 is a cross-sectional view illustrating another example of the display device DSP illustrated in FIG. 7. The display device DSP illustrated in FIG. 9 corresponds to a combination of the third configuration example illustrated in FIG. 6 and the fourth configuration example illustrated in FIG. 7.

Similarly to the third configuration example, the first transparent layer 71 is provided between the first cover member 51 and the first transparent substrate 10, between the first cover member 51 and the first light guide 81, and between the first cover member 51 and the second light guide 82. The first transparent layer 71 has a refractive index lower than the refractive index of each of the first transparent substrate 10, the first light guide 81, and the second light guide 82.

In addition, the second transparent layer 72 is provided between the second cover member 52 and the second transparent substrate 20, between the second cover member 52 and the first light guide 81, and between the second cover member 52 and the second light guide 82. The second transparent layer 72 has a refractive index lower than the refractive index of each of the second transparent substrate 20, the first light guide 81, and the second light guide 82.

According to this configuration example, the light L1 emitted from the first light emitting element LD1 and incident on the first light guide 81 is reflected at an interface between the first light guide 81 and the first transparent layer 71 and an interface between the first light guide 81 and the second transparent layer 72. As a result, attenuation of the light L1 is suppressed between the first light emitting element LD1 and the display panel PNL. Similarly, the light L2 emitted from the second light emitting element LD2 and incident on the second light guide 82 is reflected at an interface between the second light guide 82 and the first transparent layer 71 and an interface between the second light guide 82 and the second transparent layer 72. As a result, attenuation of the light L2 is suppressed between the second light emitting element LD2 and the display panel PNL.

In addition, the luminance is uniformized in the display panel PNL. Therefore, it is possible to suppress degradation in display quality due to luminance degradation.

### Fifth Configuration Example

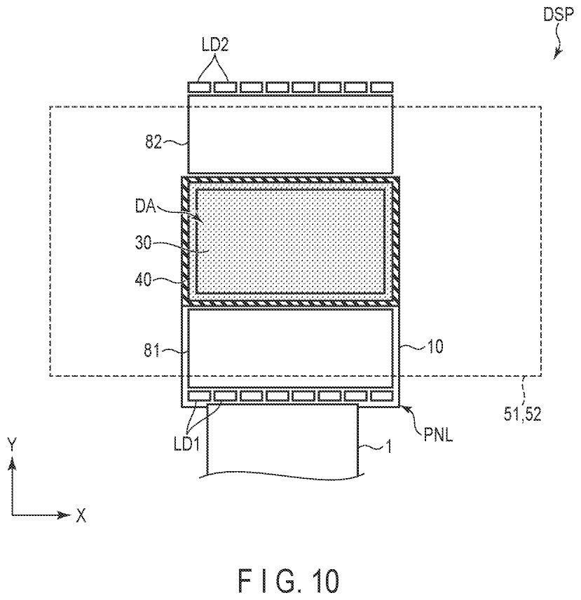

FIG. 10 is a plane view illustrating a fifth configuration example of the display device DSP. Incidentally, the first cover member 51 and the second cover member 52 are indicated by dotted lines, and the frame is not illustrated.

The fifth configuration example illustrated in FIG. 10 is different from the fourth configuration example illustrated in FIG. 7 in that the first transparent substrate 10 extends in the second direction Y in the display panel PNL. In planar view, the first light guide 81 overlaps the first transparent substrate 10, but the second light guide 82 does not overlap the display panel PNL. In addition, in planar view, the first light guide 81, the display panel PNL, and the second light guide 82 overlap the first cover member 51 and the second cover member 52.

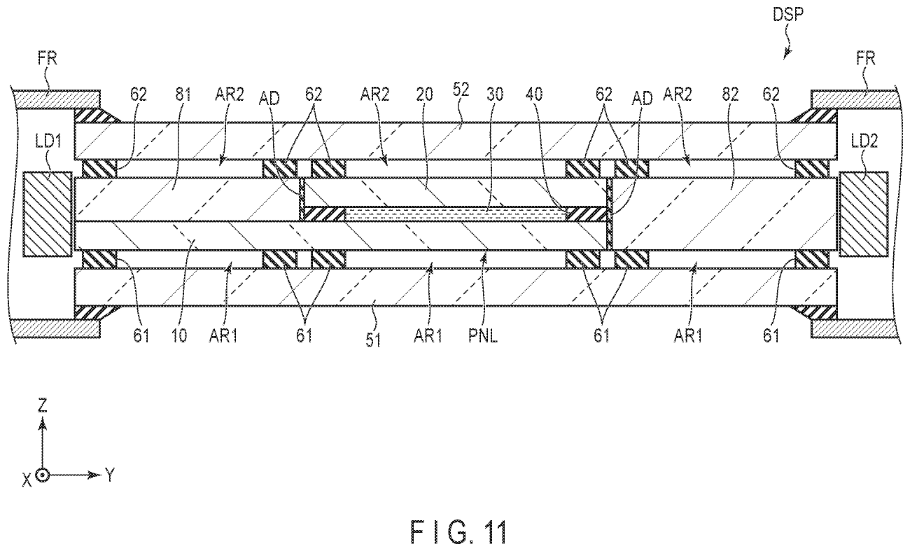

FIG. 11 is a cross-sectional view illustrating an example of the display device DSP illustrated in FIG. 10. The display device DSP illustrated in FIG. 11 corresponds to a combination of the second configuration example illustrated in FIG. 5 and the fifth configuration example illustrated in FIG. 10.

The first light guide 81 is provided between the first transparent substrate 10 and the second cover member 52 in the third direction Z. The second light guide 82 is provided between the first cover member 51 and the second cover member 52 in the third direction Z. The first light guide 81 is provided between the first light emitting element LD1 and the second transparent substrate 20 in the second direction Y, and guides the light L1 emitted from the first light emitting element LD1 to the second transparent substrate 20. The second light guide 82 is provided between the second light emitting element LD2 and the display panel PNL in the second direction Y, and guides light L2 emitted from the second light emitting element LD2 to the display panel PNL. The first light guide 81 and the second transparent substrate 20 are bonded to each other with the transparent adhesive AD. The second light guide 82 and the first transparent substrate 10, and the second light guide 82 and the second transparent substrate 20 are bonded to each other with the transparent adhesive AD.

The first spacers 61 are interposed between the first cover member 51 and the first transparent substrate 10 and between the first cover member 51 and the second light guide 82, and the air layer AR1 is located therebetween. In addition, the second spacers 62 are interposed between the second cover member 52 and the second transparent substrate 20, between the second cover member 52 and the first light guide 81, and between the second cover member 52 and the second light guide 82, and the air layer AR2 is located therebetween. According to this configuration example, the same effects as in the example illustrated in FIG. 8 can be obtained.

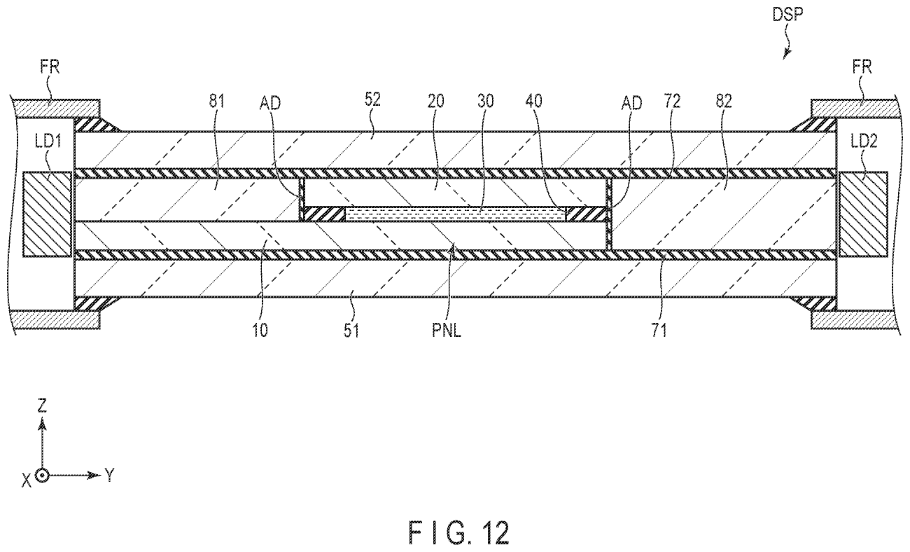

FIG. 12 is a cross-sectional view illustrating another example of the display device DSP illustrated in FIG. 10. The display device DSP illustrated in FIG. 12 corresponds to a combination of the third configuration example illustrated in FIG. 6 and the fifth configuration example illustrated in FIG. 10.

The first transparent layer 71 is provided between the first cover member 51 and the first transparent substrate 10 and between the first cover member 51 and the second light guide 82. The first transparent layer 71 has a refractive index lower than the refractive index of each of the first transparent substrate 10 and the second light guide 82. The second transparent layer 72 is provided between the second cover member 52 and the second transparent substrate 20, between the second cover member 52 and the first light guide 81, and between the second cover member 52 and the second light guide 82. The second transparent layer 72 has a refractive index lower than the refractive index of each of the second transparent substrate 20, the first light guide 81, and the second light guide 82. According to this configuration example, the same effects as in the example illustrated in FIG. 9 can be obtained.

Incidentally, in the fourth configuration example illustrated in FIG. 7 and the fifth configuration example illustrated in FIG. 10, for example, when the display area DA is disposed near to the first light emitting element LD1 (that is, in the case of being disposed near to the lower side of the illustrated first cover member 51 or the like), the first light guide 81 can be omitted.

In addition, in the example illustrated in FIG. 7, the display panel PNL is provided between the first light emitting element LD1 and the second light emitting element LD2. However, while the first light emitting element LD1 and the first light guide 81 are provided, the second light emitting element LD2 and the second light guide 82 may be omitted.

As described above, according to the present embodiment, it is possible to provide a display device capable of suppressing degradation in display quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

An example of the display device obtained from the configurations disclosed in this specification will be additional noted.

(1) A display device comprising:

a display panel including a display area and a non-display area having optical transparency;

a frame surrounding the display panel; and

a light emitting element overlapping the frame, wherein

the display panel comprises:

a first transparent substrate;

a second transparent substrate comprising a side surface facing the light emitting element;

a liquid crystal layer provided between the first transparent substrate and the second transparent substrate and containing a polymer and a liquid crystal molecule, and

a sealant provided between the display area and the non-display area and sealing the liquid crystal layer in the display area, and

the non-display display area is located between the frame and the display area in planar view. (2) The display device according of item (1), wherein

the display panel comprises:

a wiring line group provided in a wiring line region of the non-display area; and

a dummy electrode provided in a non-wiring line region adjacent to the wiring line region of the non-display area, and

a transmittance of the wiring line region is equal to a transmittance of the non-wiring line region.

(3) The display device according to item (1), comprising:

a first cover member; and

a second cover member,

wherein

air layers are each located between the first cover member and the first transparent substrate and between the second cover member and the second transparent substrate.

(4) The display device according to item (3), comprising:

a first spacer provided between the first cover member and the first transparent substrate; and

a second spacer provided between the second cover member and the second transparent substrate, wherein

the first spacer and the second spacer overlap the non-display area, and

the air layers overlap the display area.

(5) The display device according to item (1), comprising:

a first cover member;

a second cover member;

a first transparent layer provided between the first cover member and the first transparent substrate; and

a second transparent layer provided between the second cover member and the second transparent substrate, wherein

the first transparent layer is in contact with the first transparent substrate and has a lower refractive index than the first transparent substrate, and

the second transparent layer is in contact with the second transparent substrate and has a lower refractive index than the second transparent substrate.

(6) The display device according to item (5), wherein the first transparent layer and the second transparent layer overlap both the display area and the non-display area.

(7) A display device comprising:

a first cover member;

a second cover member;

a display panel provided between the first cover member and the second cover member;

a first spacer provided between the first cover member and the display panel; and

a second spacer provided between the second cover member and the display panel, wherein

the display panel comprises:

a first transparent substrate;

a second transparent substrate; and

a liquid crystal layer provided between the first transparent substrate and the second transparent substrate and containing a polymer and a liquid crystal molecule; and

in cross-sectional view, air layers are each located between the first cover member and the first transparent substrate and between the second cover member and the second transparent substrate.

(8) The display device according to item (7), wherein

the display panel includes a display area and a non-display area,

the first spacer and the second spacer overlap the non-display area, and

the air layers overlap the display area.

(9) The display device according to item (7), comprising:

a light emitting element; and

a light guide provided between the first cover member and the second cover member and configured to guide light emitted from the light emitting element to the display panel, wherein

the air layers are each located between the first cover member and the light guide and between the second cover member and the light guide.

(10) The display device according to item (7), comprising:

a light emitting element; and

a light guide provided between the first transparent substrate and the second cover member and configured to guide light emitted from the light emitting element to the second transparent substrate, wherein

the air layers are each located between the first cover member and the first transparent substrate and between the second cover member and the light guide.

(11) A display device comprising:

a first cover member;

a second cover member;

a display panel provided between the first cover member and the second cover member;

a first transparent layer provided between the first cover member and the display panel in cross-sectional view; and

a second transparent layer provided between the second cover member and the display panel in cross-sectional view, wherein

the display comprises:

a first transparent substrate;

a second transparent substrate; and

a liquid crystal layer provided between the first transparent substrate and the second transparent substrate and containing a polymer and a liquid crystal molecule,

the first transparent layer is in contact with the first transparent substrate and has a lower refractive index than the first transparent substrate, and

the second transparent layer is in contact with the second transparent substrate and has a lower refractive index than the second transparent substrate.

(12) The display device according to item (11), wherein

the display panel includes a display area and a non-display area, and

the first transparent layer and the second transparent layer overlap both the display area and the non-display area.

(13) The display device according to item (11), comprising:

a light emitting element; and

a light guide provided between the first cover member and the second cover member and configured to guide light from the light emitting element to the display panel, wherein

the first transparent layer is provided between the first cover member and the light guide, is in contact with the light guide, and has a lower refractive index than the light guide, and

the second transparent layer is provided between the second cover member and the light guide, is in contact with the light guide, and has a lower refractive index than the light guide.

(14) The display device according to claim 11, comprising:

a light emitting element; and

a light guide provided between the first transparent substrate and the second cover member and configured to guide light from the light emitting element to the second transparent substrate, wherein

the second transparent layer is provided between the second cover member and the light guide, is in contact with the light guide, and has a lower refractive index than the light guide.

What is claimed is:

1. A display device comprising:
a display panel including a display area and a non-display area that surrounds the display area and has optical transparency;
a frame that surrounds a peripheral portion of the display panel and exposes a part of the non-display area and the display area; and
a light emitting element overlapping the frame, wherein
the display panel comprises:
a first transparent substrate;
a second transparent substrate comprising a side surface facing the light emitting element; and
a liquid crystal layer provided between the first transparent substrate and the second transparent substrate and containing a polymer and a liquid crystal molecule, and
the part of the non-display area is located between the frame and the display area in planar view.

2. The display device according to claim 1, wherein
the display panel comprises:
a wiring line group provided in a wiring line region of the non-display area; and
a dummy electrode provided in a non-wiring line region adjacent to the wiring line region of the non-display area, and
a transmittance of the wiring line region is equal to a transmittance of the non-wiring line region.

3. The display device according to claim 1, comprising:
a first cover member located on a side of the first transparent substrate opposite to the liquid crystal layer; and
a second cover member located on a side of the second transparent substrate opposite to the liquid crystal layer, wherein
air layers are each located between the first cover member and the first transparent substrate and between the second cover member and the second transparent substrate.

4. The display device according to claim 3, comprising:
a first spacer provided between the first cover member and the first transparent substrate; and
a second spacer provided between the second cover member and the second transparent substrate, wherein
the first spacer and the second spacer overlap the non-display area, and
the air layers overlap the display area.

5. The display device according to claim 1, comprising:
a first cover member located on a side of the first transparent substrate opposite to the liquid crystal layer;
a second cover member located on a side of the second transparent substrate opposite to the liquid crystal layer;
a first transparent layer provided between the first cover member and the first transparent substrate; and
a second transparent layer provided between the second cover member and the second transparent substrate, wherein
the first transparent layer is in contact with the first transparent substrate and has a lower refractive index than the first transparent substrate, and
the second transparent layer is in contact with the second transparent substrate and has a lower refractive index than the second transparent substrate.

6. The display device according to claim 5, wherein the first transparent layer and the second transparent layer overlap both the display area and the non-display area.

7. A display device comprising:
a display panel including a first transparent substrate, a second transparent substrate, and a liquid crystal layer provided between the first transparent substrate and the second transparent substrate and containing a polymer and a liquid crystal molecule;
a first cover member located on a side of the first transparent substrate opposite to the liquid crystal layer;
a second cover member located on a side of the second transparent substrate opposite to the liquid crystal layer;
a first spacer provided between the first cover member and the first transparent substrate; and
a second spacer provided between the second cover member and the second transparent substrate, wherein
in cross-sectional view, air layers are each located between the first cover member and the first transparent substrate and between the second cover member and the second transparent substrate.

8. The display device according to claim 7, wherein
the display panel includes a display area and a non-display area,
the first spacer and the second spacer overlap the non-display area, and
the air layers overlap the display area.

9. The display device according to claim 7, comprising:
a light emitting element; and
a light guide provided between the first cover member and the second cover member and configured to guide light emitted from the light emitting element to the display panel, wherein
the air layers are each located between the first cover member and the light guide and between the second cover member and the light guide.

10. The display device according to claim 7, comprising:
a light emitting element; and
a light guide provided between the first transparent substrate and the second cover member and configured to guide light emitted from the light emitting element to the second transparent substrate, wherein
the air layers are each located between the first cover member and the first transparent substrate and between the second cover member and the light guide.

11. A display device comprising:
a display panel including a first transparent substrate, a second transparent substrate, and a liquid crystal layer provided between the first transparent substrate and the second transparent substrate and containing a polymer and a liquid crystal molecule;
a first cover member located on a side of the first transparent substrate opposite to the liquid crystal layer;
a second cover member located on a side of the second transparent substrate opposite to the liquid crystal layer;
a first transparent layer provided between the first cover member and the first transparent substrate in cross-sectional view; and
a second transparent layer provided between the second cover member and the second transparent substrate in cross-sectional view, wherein
the first transparent layer is in contact with the first transparent substrate and has a lower refractive index than the first transparent substrate, and
the second transparent layer is in contact with the second transparent substrate and has a lower refractive index than the second transparent substrate.

12. The display device according to claim 11, wherein
the display panel includes a display area and a non-display area, and
the first transparent layer and the second transparent layer overlap both the display area and the non-display area.

13. The display device according to claim 11, comprising:
a light emitting element; and
a light guide provided between the first cover member and the second cover member and configured to guide light from the light emitting element to the display panel, wherein
the first transparent layer is provided between the first cover member and the light guide, is in contact with the light guide, and has a lower refractive index than the light guide, and
the second transparent layer is provided between the second cover member and the light guide, is in contact with the light guide, and has a lower refractive index than the light guide.

14. The display device according to claim 11, comprising:
a light emitting element; and
a light guide provided between the first transparent substrate and the second cover member and configured to guide light from the light emitting element to the second transparent substrate, wherein
the second transparent layer is provided between the second cover member and the light guide, is in contact with the light guide, and has a lower refractive index than the light guide.

15. The display device according to claim 7, wherein
the display panel comprises:
a display area; a non-display area surrounding the display area and having optical transparency; a wiring line group provided in a wiring line region of the non-display area; and a dummy electrode provided in a non-wiring line region adjacent to the wiring line region of the non-display area, and
a transmittance of the wiring line region is equal to a transmittance of the non-wiring line region.

16. The display device according to claim 11, wherein
the display panel comprises:
a display area; a non-display area surrounding the display area and having optical transparency; a wiring line group provided in a wiring line region of the non-display area; and a dummy electrode provided in a non-wiring line region adjacent to the wiring line region of the non-display area, and
a transmittance of the wiring line region is equal to a transmittance of the non-wiring line region.
